(19) United States
(12) Patent Application Publication
(10) Pub. No.: US 2005/0109972 A1
(43) Pub. Date: May 26, 2005

(54) Connector for fuel cell

(75) Inventors: Jeffrey R. Powers, Larchmont, NY (US); Paul Gaudron, Stamford, CT (US)

Correspondence Address: MORGAN LEWIS & BOCKIUS LLP, 1111 PENNSYLVANIA AVENUE NW, WASHINGTON, DC, 20004, US

(73) Assignee: Powers Fasteners, Inc.

(21) Appl. No.: 10/719,985

(22) Filed: Nov. 24, 2003

(51) Int. Cl. F16K 1/00

(52) U.S. Cl. 251/330

(57) ABSTRACT

A fuel cell includes a body, and a valve for releasing dispensable fluid from the body. The valve includes an elongated stem. A unitary member is secured to the body by its first end being secured to the stem. The unitary member includes a connector formed at a second end and a fluid conduit extending between the first and second ends. The connector is adapted for sealingly engaging a dispensable fluid inlet.

The invention relates generally to a fuel cell for a combustion gas-powered tool. More particularly, the invention relates to a connector for connecting a valve of the fuel cell to the combustion gas-powered tool.

### BACKGROUND OF THE INVENTION

Fuel cells for a combustion gas-powered tool, and connectors for connecting a valve of a fuel cell to a combustion gas-powered tool, are known. U.S. Pat. No. 5,115,944 discloses a fuel cell of the type having an outer canister containing a pressurized propellant, an inner bag containing a dispensable fluid, and a valve for dispensing the fluid to a combustion gas-powered tool. When the valve is open, the pressurized propellant collapses the inner bag and forces the fluid to be dispensed from the inner bag through a valve stem of the open valve. U.S. Pat. No. 6,523,860 discloses an adapter system for connecting a valve of a fuel cell to a combustion gas-powered tool. The adapter system includes two components—an adapter and a molded insert. The molded insert is secured within a passageway in the adapter, then the adapter is placed onto the fuel cell such that a valve stem of the fuel cell is inserted into a first end of the molded insert. A base portion of the adapter includes barbs that engage a rolled seam of the fuel cell canister to secure the adapter onto the fuel cell. With the adapter secured to the fuel cell, the molded insert secured within the adapter, and the fuel cell valve stem inserted into one end of the molded insert, a fuel metering valve stem on the tool is inserted into a second end of the molded insert for abutting engagement with the fuel cell valve stem.

It would be desirable to have a fuel cell having a simplified connector for engaging with a fuel inlet of a combustion gas-powered tool. It would also be desirable to have a connector that can be affirmatively connected directly to a valve stem of the fuel cell, and for the connector to be easily connected with a stem of a fuel metering valve in the combustion gas-powered tool so as to establish a leak resistant fluid conduit between the fuel cell and the fuel metering valve. It would also be desirable to have a connector which is permanently connected to a fuel cell and/or which can be easily affixed to the fuel stem.

### SUMMARY OF THE INVENTION

The above needs are met, and the shortcomings of prior art are overcome by the fuel cell connector of the invention. In particular, the invention provides a fuel cell having a unitary connector. The connector may have a first end that is secured directly to a valve stem of the fuel cell. The second end of the connector may be adapted to be easily engaged with a fuel metering valve in a combustion gas-powered tool, so as to establish a leak resistant fluid conduit between the fuel cell and the fuel metering valve.

According to one embodiment, a fuel cell includes a body, and a valve having a stem for releasing dispensable fluid from the body. A unitary member is secured to the body by its first end being fixedly secured to the stem. The member has a connector formed at a second end, and a fluid conduit extending between the first and second ends, such that the connector is adapted for sealingly engaging a dispensable fluid inlet.

The stem may extend parallel to a first axis, and the fluid conduit may extend parallel to the first axis. The connector may include an aperture that is circumscribed by a channel. The first end of the member may approximate a conical section, and the second end of the member may approximate a cylindrical section. The stem axis may be both parallel and collinear with the axis of revolution for the first and second ends. The connector may be a female fitting adapted for engaging a male inlet stem. The second end may include an outer flange and an inner flange spaced from, and circumscribed by the outer flange, the inner flange being adapted for engaging a fluid inlet stem. The fuel cell may be combined with a tool having a fluid inlet. The fluid inlet may include a male stem, wherein the female fitting is engaged with the male stem to provide a fluid tight seal.

In another embodiment, a method for connecting a fuel cell to a tool having a dispensable fluid inlet is provided. The fuel cell includes a body containing a dispensable fluid, a stem and valve. The valve is opened by depressing the stem. The method includes the steps of providing a unitary adapter fixedly secured to an end of the stem, the adapter defining a fluid passageway extending between the stem and a connector formed at an end of the adapter; and engaging the dispensable fluid inlet with the connector so that there is a fluid-tight seal formed between the fuel cell stem and the dispensable fluid inlet.

The engaging step may include inserting a male stem of the tool into an aperture of the connector and the aperture may include structure for press-fitting the male stem into the aperture. The press-fitting step may include forcibly inserting an end of the inlet stem beyond a ridge provided on the adapter.

Additional features and advantages of the invention will be set forth or be apparent from the description that follows. The features and advantages of the invention will be realized and attained by the structures and methods particularly pointed out in the written description and claims hereof as well as the appended drawings.

It is to be understood that both the foregoing general description and the following detailed description are exemplary and explanatory and are intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate preferred embodiments of the invention and together with the description serve to explain the principles of the invention. In the drawings:

FIG. 1 is a perspective view of a preferred embodiment of a fuel cell and a connector incorporating the principles of invention.

FIG. 2a is a cross-sectional view of the connector of FIG. 1.

FIG. 2b is a top view of the connector of FIG. 1.

FIG. 2c is a bottom view of the connector of FIG. 1.

FIG. 3 is a partial cross-sectional view of the fuel cell and connector of FIG. 1, and a metering valve of a combustion gas-powered tool, incorporating the principles of invention.

### DETAILED DESCRIPTION OF THE PREFERRED EMBODIMENTS

A fuel cell connector of the invention provides a one-piece member which connects a fuel cell to a valve stem of a metering valve in a combustion gas-powered tool. When connected, a fluid-tight seal may be established between the fuel cell contents and the tool without the use of additional fitting structure. A lower portion of the connector member may be fixed to the valve stem of the fuel cell, and an upper portion of the connector member may be adapted for a press fit on the valve stem of the metering valve. In this regard, the upper portion of the connector member may include a flexible wall having an inner diameter that is slightly less than the outer diameter of valve stem on the metering valve, to provide a frictional and/or interference-type hold on the metering valve stem, and a gap may be disposed radially outward from the flexible wall to provide a space for the displaced wall in the flexed condition. A fluid conduit is formed between the lower and upper portions so that a dispensable fluid may pass from the fuel cell, through the fuel cell valve stem and the metering valve stem, to a metering valve of the combustion gas-powered tool.

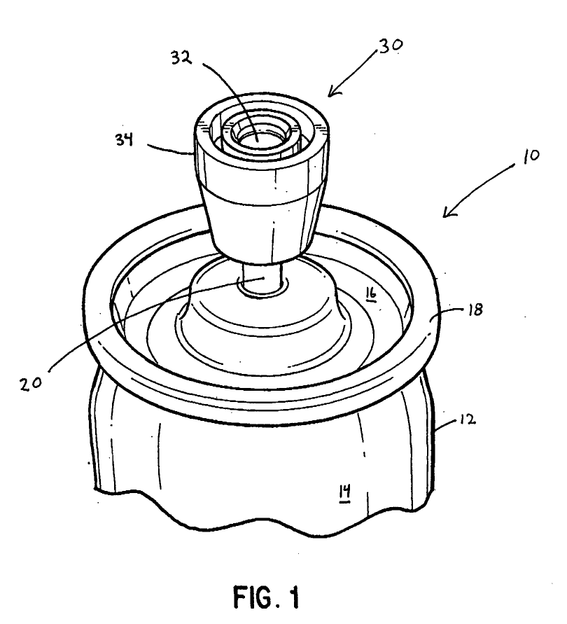

A preferred embodiment of a fuel cell and connector of the invention is illustrated in FIG. 1. Fuel cell 10 includes an outer canister 12 having an elongated cylindrical tube 14 and a circular cover 16. Tube 14 and cover 16 are generally made of a suitable metal material. The cover 16 is connected to tube 14 at a rolled seam 18 to form a gas-impermeable seam. As is known in the art, an inner bag (not shown), containing a dispensable fluid, may be disposed within the canister 12. A pressurized propellant is stored within the canister 12 around the inner bag. When the fuel cell valve is open, the pressurized propellant collapses the inner bag and forces the fluid to be dispensed from the bag through a valve stem 20. It is to be understood that the invention is not limited to this type of fluid dispensing canister. A unitary connector member 30 is secured at a dispensing end of a valve stem 20. Connector member 30 may be made of soft plastic, a relatively inelastic plastic, or rubber, for example. Connector member 30 includes a conduit 32 for fluid flowing between the dispensing end of the valve stem 20 and a metering valve of a combustion gas-powered tool. A connector member of the invention may include structure for securing or coupling it to a metering valve, such as that which is formed at portion 34, as described below.

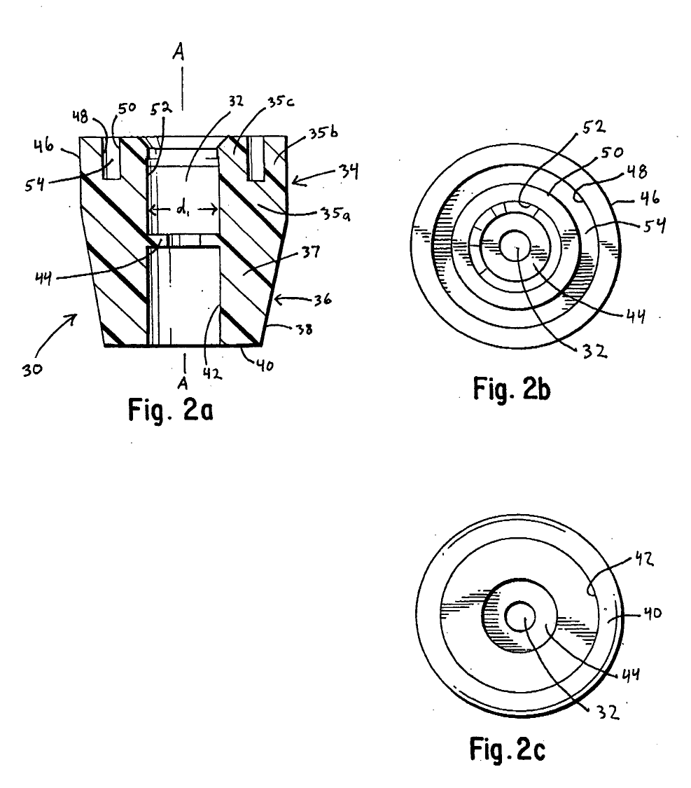

Referring to FIGS. 2a, 2b and 2c, connector member 30 generally includes a lower portion 36, an upper portion 34, and a fluid conduit 32 extending between lower portion 36 and upper portion 34. As shown, connector 30 is symmetrical about axis A-A, but this is not a requirement of the invention. Lower portion 36 includes structure that may be engaged with the fuel cell valve stem 20. Lower portion 36 includes a wall 37 having an outside surface 38, an inside surface 42, and a bottom surface 40 extending between outside surface 38 and inside surface 42. The outside surface 38 is in the form of a conic section, while the inside surface 42 is in the form of a right cylinder. Other embodiments of the invention may employ shapes other than conic or cylindrical. Accordingly, these shapes employed for the connector should not be viewed as a limitation on the invention except as where specifically recited in the claim(s). Inside surface 42 defines a lower portion of fluid conduit 32, and extends between bottom surface 40 to a flange 44 along the longitudinal axis A-A. Flange 44 extends radially inward from inside surface 42 and provides a stop for fuel cell valve stem 20, as more fully described below. Conduct 32 may also be fit with soft, rubber-like seals or gaskets (not shown) at one or both of upper and lower portions 32, 34 for purposes of enhancing a fluid seal during operation.

As noted earlier, upper portion 34 forms a connection to a metering valve stem on a combustion gas-powered tool. Upper portion 34 includes an outer wall 35b, an inner wall 35c, and a base portion 35a. Outer wall 35b includes an outside surface 46 and an inside surface 48. Inner wall 35c includes an outside surface 50 and an inside surface 52. Each surface 46, 48, 50 and 52 is in the form of a right cylinder. Inside surface 52 forms a right cylinder having a diameter d₁. Surface 48 and surface 50 define a gap 54 which may be useful as a means for increasing flexibility of the wall 35c when receiving a slightly larger dimensioned stem of a metering valve. As such, inner wall 35c can be sized to flex when the metering valve stem of the combustion gas-powered tool is received in portion 34, as described below. Thus, gap 54 maybe thought of as a flexure space for resilient inner wall 35c. Inside surface 52 defines an upper portion of fluid conduit 32 and extends along the longitudinal axis A-A to flange 44. Flange 44 also provides a stop for the metering valve stem. A material that yields (rather than an elastic material) upon insertion of the metering valve may alternatively be used. Such engagements may also be used for end 36.

In use, connector 30 is fixed to stem 20 by either an adhesive or heat shrink. Fuel cell 10 may then be packaged and delivered with a connector 30 secured thereto. Thus, in one embodiment of the invention, there is provided a fuel cell having a integral connector for connecting the fuel cell to a tool. In another embodiment, connector 30 may be delivered separately and then secured to the end of a fuel cell, such as the fuel cell disclosed in U.S. Pat. No. 5,115,944.

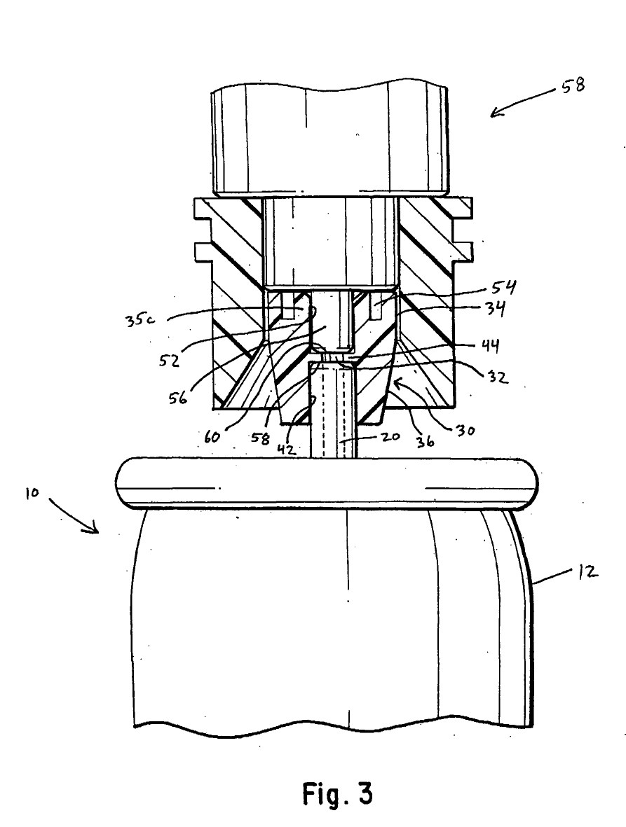

As illustrated in FIG. 3, connector member 30 provides a fluid conduit between the valve stem 20 of the fuel cell 10 and a valve stem 56 of a metering valve 58 in a combustion gas-powered tool. In one embodiment, connector 30 is first inserted onto stem 20 before engaging connector 30 with stem 56. Valve stem 20 is inserted into lower portion 36 of the connector member 30 so that an end 58 of the valve stem 20 abuts flange 44. In another embodiment, connector 30 is already secured to stem 20 and the user may then simply connect connector 30 to stem 56. Valve stem 20 may be adhered to inside wall 42 by an adhesive, to form an integral connection to the connection member 30. In the illustrated embodiment, connector member 30 is sized for being received in fuel metering valve 58 such that stem 56 engages surface 52. The valve stem 56 may be inserted into upper portion 34 so that an end 60 of the valve stem 56 abuts the flange 44. Valve stem 56 has a diameter slightly larger than diameter d₁ of inside surface 52, so that valve stem 56 may be press fit into upper portion 34 to form a frictional engagement with inside wall 52. Alternatively, a circular ridge may be formed on surface 52 to form an interference fit between connector member 30 and stem 56. The valve stem 56 may be made of a hard material such as metal, and the connector member 30 may be made of a flexible material such as plastic, so that when valve stem 56 is press fit into upper portion 34, the inner wall 35c elastically flexes radially outward from axis A-A. Gap 54 provides a flexure space to allow inner wall 35c to flex radially outward.

With the lower portion 36 of connector member 30 secured to the valve stem 20, and the upper portion 34 of connector member 30 press fit on the valve stem 56, a dispensable fluid may pass from the fuel cell 10 through valve stem 20, fluid conduit 32, and valve stem 56, to the metering valve 58 of a combustion gas-powered tool.

In a preferred embodiment, upper portion 34 is adapted to receive a protruding stem and as such, a female type fitting is formed. Additionally, outer walls 35b may be sized such that when connector 30 is to be connected to stem 56, walls 35b assist with aligning conduit 32 with stem 56.

Although the foregoing description is directed to the preferred embodiments of the invention, it is noted that other variations and modifications will be apparent to those skilled in the art, and may be made without departing from the spirit or scope of the invention.

1. A fuel cell, comprising:
a body and a valve for releasing dispensable fluid from the body, the valve including a stem;
a unitary member secured to the body by its first end being fixedly secured to the stem, the member including a connector formed at a second end and a fluid conduit extending between the first and second ends, wherein the connector is adapted for sealingly engaging a dispensable fluid inlet.

2. The fuel cell of claim 1, wherein the stem extends parallel to a first axis and the fluid conduit extends parallel to the first axis.

3. The fuel cell of claim 1, wherein the connector includes an aperture that is circumscribed by a channel.

4. The fuel cell of claim 1, wherein the member first end approximates a conical section, the second end approximates a cylindrical section and the stem axis is both parallel and collinear with the axis of revolution for the first and second ends.

5. The fuel cell of claim 1, wherein the connector is a female fitting adapted for engaging a male inlet stem.

6. The fuel cell of claim 1, wherein the second end includes an outer flange and an inner flange spaced from, and circumscribed by the outer flange, the inner flange being adapted for engaging a fluid inlet stem.

7. The fuel cell of claim 5, in combination with a tool having a fluid inlet and the inlet including a male stem, wherein the female fitting is engaged with the male stem to thereby provide a fluid tight seal.

8. A method for connecting a fuel cell to a tool having a dispensable fluid inlet, the fuel cell including a body containing a dispensable fluid, a stem and valve, wherein the valve is opened by depressing the stem, comprising the steps of:
providing a unitary adapter fixedly secured to an end of the stem, the adapter defining a fluid passageway extending between the stem and a connector formed at an end of the adapter; and
engaging the dispensable fluid inlet with the connector whereupon engagement with the connector there is a fluid-tight seal formed between the fuel cell stem and dispensable fluid inlet.

9. The method of claim 8, wherein the engaging step includes inserting a male stem of the tool into an aperture of the connector.

10. The method of claim 9, wherein the inserting step includes press-fitting the male stem into the aperture.

11. The method of claim 10, wherein the press-fitting step includes forcibly inserting an end of the inlet stem beyond a ridge provided on the adapter.

12. A fuel cell, comprising:
a canister having a stem for expelling fluid from the canister; and
a unitary member that is integral with the stem and includes a conduit and connector formed therein, wherein the conduit is in fluid communication with the connector and the connector is adapted for sealingly engaging a dispensable fluid inlet.

13. The fuel cell of claim 12, wherein the conduit includes a first portion having a first diameter suited for sealingly engaging the stem, a second portion having a second diameter that is less than the first diameter, and a third portion having a third diameter that is greater than the second diameter.

14. The fuel cell of claim 13, wherein the second diameter approximates a fluid exit diameter of the stem.

15. The fuel cell of claim 12, wherein the connector is a female connector.

16. The fuel cell of claim 15, wherein the female connector includes a hole surrounded by a flange.

17. The fuel cell of claim 16, wherein the flange includes a protuberance formed on an inner wall thereof.

18. A fuel cell, comprising:
a canister having a stem for expelling fluid from the canister; and
a means for securing the canister to a valve so as to establish a fluid-tight seal with the valve, the means being integral with the canister.

19. The fuel cell of claim 18, wherein the means includes a female interface.

20. The fuel cell of claim 18, wherein the means is a one-piece connector fixedly secured to the stem.
